(19) United States
(12) Patent Application Publication
(10) Pub. No.: US 2003/0080166 A1
(43) Pub. Date: May 1, 2003

(54) Holding rack and multiple purposes box for vehicles

(76) Inventor: Miguel Angel Levinson De los Cobos, Col. Tlacopac San Angel (MX)

Correspondence Address: LARSON & TAYLOR, PLC, 1199 NORTH FAIRFAX STREET, SUITE 900, ALEXANDRIA, VA, 22314, US

(21) Appl. No.: 10/273,997

(22) Filed: Oct. 21, 2002

(30) Foreign Application Priority Data
Oct. 25, 2001 (MX) PA/A/2001/010841

(51) Int. Cl. B60R 9/048; B60R 9/055

(52) U.S. Cl. 224/319; 224/321; 224/324; 224/328

(57) ABSTRACT

The current invention is related to a holding rack to be used in the vehicle's roof, hood, or curved, semi-flat or flat tarpaulin, the holding rack includes an inferior member placed adjacently to the vehicle's roof or flat surface, being removable attached directly to the vehicle's surface, where the inferior member allows easily to be installed/removed to and from the holding rack. A middle member placed adjacently and linked to the inferior member of the holding rack, such inferior member constitutes the basis where the superior and inferior members will be attached to fix the settings of the holding rack. A superior member is placed adjacently and linked to the middle member, where the superior member constitutes a number of transverse elements placed and fixed to the middle member, which combine with the middle member of the holding rack set a number of spaces used as rails or lanes to allow the insertion and locking of the multiple purposes box. The current invention is also related to a multiple purposes box to be used with the holding rack.

### INVENTION FIELD

The current invention is related to an assembly and holding device for luggage rack in vehicles, specifically in a roof rack or in a flat or semi-flat surface vehicle. The invention is also related to a combined multi purposes box, particularly designed to lock the holding rack.

### BACKGROUND OF THE INVENTION

There is a varied market of this kind of devices to carry and hold articles on vehicle's roof such as luggage, boxes, ice bucket, sports goods, bikes, ski, kayaks, and certain objects that can not be carries due to their size or can not be carried in the trunk. These devices used to carry and move items on the vehicle's roof are commonly known as “roof racks” and/or holding racks. These articles are available and can be installed from the automotive plant or in other cases, they could be installed after buying the vehicle. These devices work as roof racks after the vehicle's purchase and work as racks work.

The most simple designs of roof racks and/or tubular rack are generally made by at least a pair longitudinal rods or rails and two ties fixed permanently to the roof by mechanical elements. These devices are like holding frames that carry items; nevertheless these devices need supplementary elastic elements to hold the items in such racks. For instance, some of them are described in general in the Mexican Patent number 142095, named “Mejoras a Dispositivo Portaequipaje para colocarse en el capacete de un automovil”, granted on Aug. 11^{th}, 1980 to James Ernest Zane and others; Mexican Patent number 173351 named “Montante de soporte para portaequipaje” granted on Mar. 27^{th}, 1995 to Clair Inc.; and the Mexican Patents numbers 175674 and 175675 both named “Portaequipajes para vehiculo” granted on Aug. 12^{th}, 1994 to Masco industries Inc. Each of them is attached by reference.

Some efforts have been made to improve functional and mechanical, magnetic or suction holding features, of the roof rack and racks for items for vehicle, which are described in the Spanish Patent number 1007459 and 1027656; Spanish Utility model number 159U, European Patents publications numbers 0363692, 0653329, 0635397, 0511179, 0274835, 0273480, 0176404, 0190118, 0193501, 0492513, 0324914, 0597251, 0664241, 0635397, 0635387. International Publication WO 87/07568, WO 83/02430, WO 95/20503, WO 94/21491 and WO 99122963; U.S. Pat. Nos. 5,954,251 and 4,586,638, 3,715,044. For instance, the European Patent number EP-0597251B1 describes a ski carrier combined with rubber sheets stick by suction, and adherent sheets, by vacuum-suction to be set on the vehicle's roof.

Unfortunately, most of the technique efforts have been focused only in improving the specific regulations and holding mechanisms in any kind of rack to carry items such as luggage. However, many of the devices on the vehicle's roof are already fixed and are very difficult to be removed, many of them need particular tools to be removed. Many other devices to hold and carry items on the vehicle's roof do not offer a safety holding means, by themselves, for the items or articles that are within the rack and they do not protect items from the environment either. In order to give a safety holding mean for the articles within the rack, such devices to take and hold items on the vehicle's roof use elastic bands or ropes named “bungee ropes”, which do not offer any guarantee during the journey.

Another important characteristic is that the boxes that take and hold items on the vehicle's roof, particularly luggage or roof racks due to their size, they offer a reduced load area and they have a high manufacturing price. This specific boxes designed is limited on the installation over the racks, generally used in pick up trucks and owe to its specific design the boxes are fixed on the racks and they need certain tools to be removed.

According to the previous features, there is a need for a holding rack that gives an extra load space of any type of vehicle that has a tarpaulin or hood on which you are able to install a rack. There is also the need of another multiple purposes box that can be put into and slid the holding rack to be protected of the environment. Therefore, the purpose of the current invention item is to give a constructing and simple working holding rack but highly efficient to hold and carry a multiple purposes box on the vehicle's roof.

Other objective is to provide a much more secure, easy installation, which can be used in any combustion engine vehicle, and an economical holding rack.

Other purpose of the current invention is to offer/provide a mixture of a holding rack with a multiple purposes box that keep safe all the items from the exposure to the elements.

There is another purpose of the current invention, which is to give a box that can be manufactured in varied models and types in order to meet any need.

### SUMMARY OF THE INVENTION

The current invention is related to a holding rack to be used in a curved, semi-flat or flat tarpaulin or hood of any vehicle; the holding rack includes an inferior member set adjacently to the vehicle's hood or flat surface, being such inferior member fixed directly, in certain way that can be removed from such flat surface of the vehicle where the inferior member allows to install/remove easily from the holding rack. An inferior middle member is set adjacently and linked to the inferior member of the holding rack, such a middle member constitutes the basis where the superior and inferior members are attached as to regulate the holding rack configuration. A superior member is set adjacently and linked to the middle member, where the superior member includes transverse elements plurality set and safely fixed to the middle member, which combined with the holding rack give us as a result a plurality of spaces that can be used as rails or lanes to allow the insertion and safety of the multiple purposes box. The current invention is also related to the multiple purposes box to be used with the holding rack.

### DRAWINGS BRIEF DESCRIPTION

All the characteristic aspects in the current invention will be set in the attached demands. However, the invention, the organization as well as the working method, with other objects and advantages will be better understood in the following description of certain embodiments when it is read along with the drawings, in which:

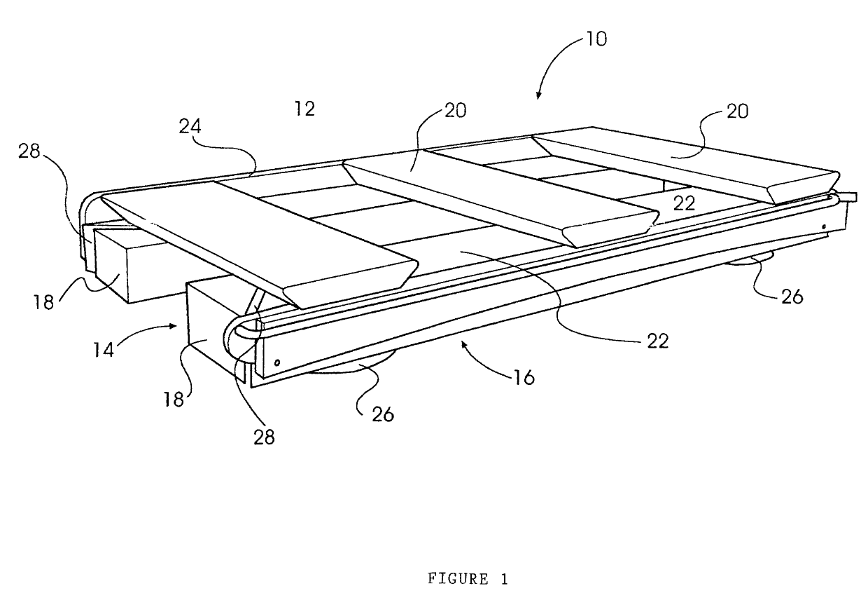

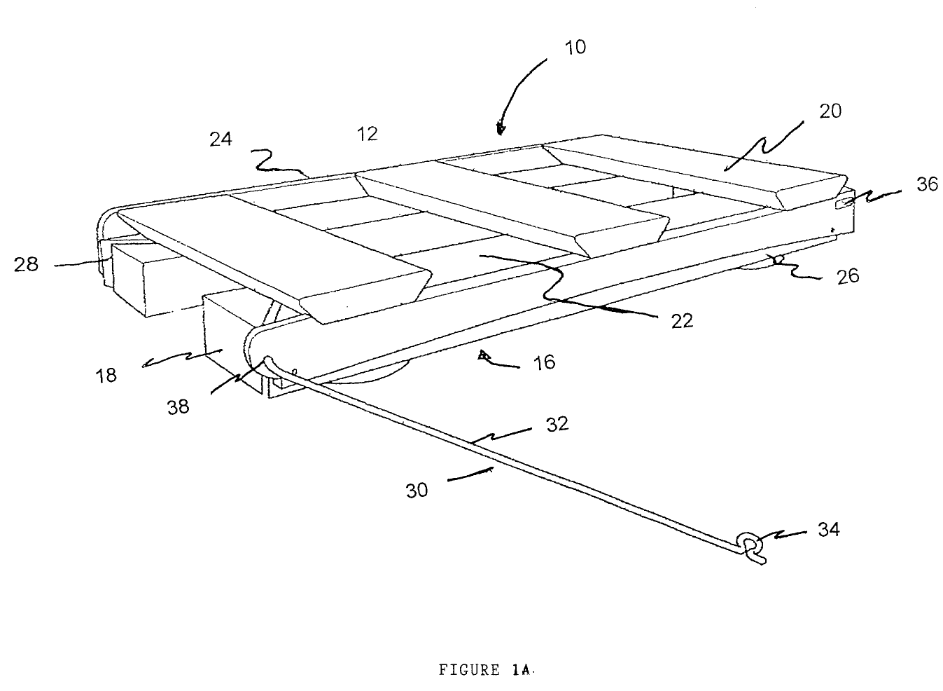

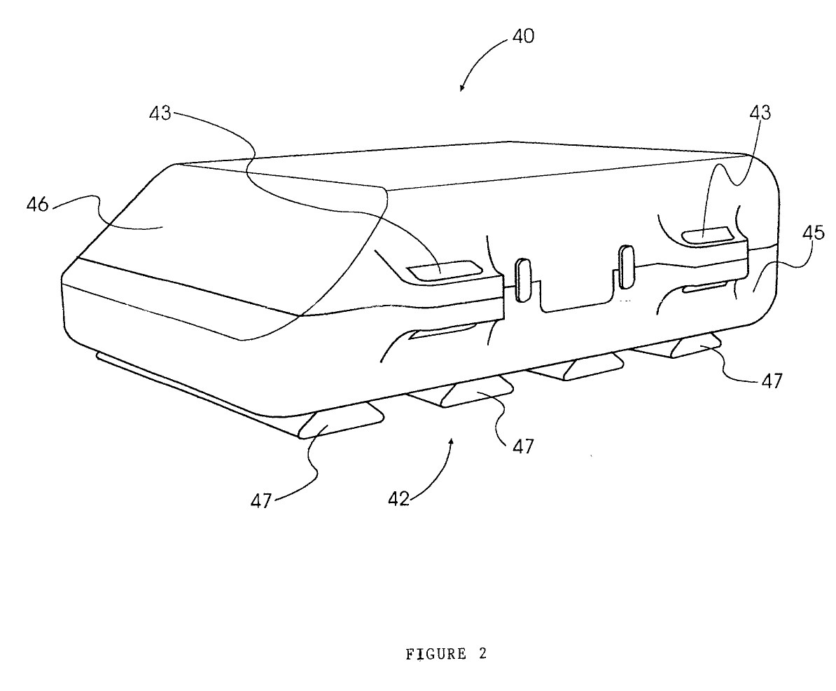

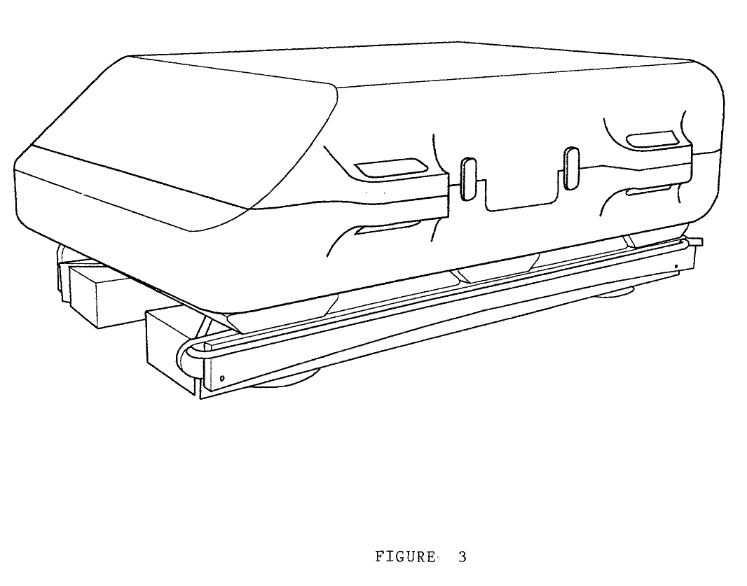

Drawing or FIG. 1 is a perspective view of the holding rack that is mentioned in this invention.

Drawing 1A is a perspective view of the holding rack showed when it is unlocked from the secured of member of the box.

Drawing 2 is a perspective view of the multiple purposes box from the current invention.

Drawing 3 is a perspective view of the multiple purposes box placed in the holding rack of the current invention.

Although the invention can have different modifications and alternatives, it has been shown, by way of examples, a specific carry out way of the item and will be described in detail later on. Nevertheless, the purpose is no to set limits to the invention in a specific way, is to embrace all modification, equivalents and alternatives that could be related to the invention as is protected by the attached demands.

### DETAILED DESCRIPTION OF THE PREFERRED EMBODIMENT

With reference to the drawings, more specifically drawings 1 and 1A, one preferred embodiment of the holding rack in the current invention is showed. As it is indicated in drawings 1 and 1A, the holding rack 10 is installed in the roof or curved, semi-flat or flat hood or tarpaulin.

The holding rack 10 on the current invention includes a superior member 12, a middle member 14 and a inferior member 16. The superior member of the holding rack 10 is a member, which will get and lock the multiple purposes box (it is not shown in the drawing 1), while inferior member 16 of the holding rack 10 will be fixed directly and could be removable to the vehicle's roof or tarpaulin. The middle member 14 of the holding rack 10 constitutes the sideways or basis structure where the superior member 12 and the inferior member 16 will be fixed. The preferred embodiment of the holding rack 10 is shown in drawing 1.

The middle member 14 of the holding rack 10 is constituted by a couple of longitudinal elements 18 separated in line. The longitudinal elements 18 of the middle member 14 are identical an can have any transverse section set as an square, rectangle, parallelepiped, among others, while they give the superior and inferior surfaces to get and fix the superior 12 and inferior 16 members respectively of the holding rack 10 of the current invention.

Ina preferred embodiment the longitudinal elements 18 are rectangular. The length, width and height measures of the longitudinal elements 18, as well as the division among them will depend on the design and certain factors such as the roof or tarpaulin's measures and the user's needs.

The superior member 12 of the holding rack 10 includes various transverse elements 20 placed and fixed securely to the longitudinal elements 18 of the middle member 14. The transverse elements 20 of the superior member 12 are placed perpendicularly to the longitudinal members 18 of the middle member 14 and are divided in line into equal distances. In a preferred embodiment showed in drawing 1, the holding rack 10 includes a superior member 12 that has three transverse elements 20, two of them are placed near the ends of the longitudinal elements 18 of the middle member 14 and the third transverse element 20 is placed at the center of the ends of the longitudinal elements 18. Nonetheless, the holding rack 10 can include different number of transverse elements 20, so these elements of the superior member 12 can be found at the roof or tarpaulin's wide area and combined with the longitudinal elements 18 of the middle member 14 in just one piece will withstand the multiple purposes box from the current invention.

In a preferred embodiment of the current invention, the transverse elements 20 of the superior member 12 can have diverse transversal sections such as triangular (kite tail), square, rectangular, round, star-shape (from 2 to 6 points) and in general any shape can be supplementary and easy to adapt to any inferior section of the multiple purposes box (as shown in drawing 2). When transverse elements 20 are fixed to the superior member 12 as it was described previously on the longitudinal member 18 middle member 14 of the holding rack 10, there are several spaces 22 that can work as rails or lanes to allow the insertion and safety of the multiple purposes box (as shown in drawing 3), being such box connected and slid over such rails 22. The setting can take the spaces or rails 22 depending, mainly, on the selected transverse elements 20 settings, because the longitudinal elements 14 will always give the flat surface that will supplement such rails 22 settings.

Superior 12 and middle 14 members can be manufactured in any rigid material, but preferably are made of plastic due to its flexibility, lightness and resistance to the environment.

In reference to drawing 1, the inferior member 16 of the holding rack 10 of the invention, includes at least two couples of holding members 26 to lock and attach the holding rack 10 to the vehicle's roof. Each of the pairs of holding members 26 can be found in the inferior surface of each end of the longitudinal elements 18 of the middle member 14 of such holding rack. In other embodiment, the holding elements can be within the longitudinal elements 18 of the middle member 14. The holding members 26 can be selected from any kind of known holding elements that allow to install/remove easily to and from the holding rack 10. In the preferred embodiment of the current invention, holding members 26 are suction pads which include a movable lever mechanism (not shown in drawings) that will provoke the vacuum and as a consequence the adhesion of the suction pads 26 to the vehicle's roof, tarpaulin or curved, flat or semi-flat surface. Besides, the lever of each suction pad 26 is fixed by an Allen type screw that is set in one of the sides of the holding rack and it gets into a drill that is in this side of the holding rack with one of the ends of the movable lever so as to avoid a vacuum lost in the suction pads and to lock firmly the adhesion.

The middle member 15 includes a gap or groove 28 on each end of the longitudinal elements 18 in order to activate the movable lever (not shown in drawings) of the holding member 26. Each groove is set diagonally to allow the activation of the vacuum levers of the holding members 26 and to insert easily the holding rack 10 of the current invention.

The holding rack 10 includes, moreover, a tie element 24 and a frontal member 30 to lock it (see drawing 1A). The tie element 24 is placed in the side of the holding rack and it covers longitudinally in a parallel path to a longitudinal member 18 of the middle member 14. Such tie element 24 avoids that the multiple purpose box, once is placed within the rails or lanes, from being slide out. This tie element 24 is a single sheet made of the same material of the superior, middle and inferior members and is fixed to the middle and superior members. The preferred embodiment of the tie element 24 is a fixed and unremovable ledge end and it prevents from sliding once is set in the rails 22. As is shown in drawing 1A, the locked frontal member 30 is placed at the opposite side of the tie element 24 and it will fix the box on the opposite end of the rails 22. Such locked member of the holding rack gets through longitudinally in a parallel way to the opposite longitudinal member 18 of the middle member 14. In the preferred embodiment of the current invention, the frontal locked member includes a longitudinal member in a rod shape 32 that has a fixed end 38 and a locked end 24. The fixed end 38 of the longitudinal element 32 is placed like pivot in one end of the longitudinal element 18 of the middle member, while the opposite end of the longitudinal element 18 has on its surface a rabbet or groove 36 to hold by pressure the locked end 34, keeping safe the box on the rails 22.

With regard on drawing 2, it is shown a different embodiment of the multiple purposes box of the current invention. As it is shown, this multiple purposes box 40 includes a main body shaped by the base of the box 45, a box cover 46 and a connecting member 42. The base width and length measures of the box 46 and the cover 46 are supplementary selected between them to delimitate or define the internal space where will be used to carry the luggage.

The multiple purposes box can be made from a wide range of material which will give certain characteristics such rigidity and resistance when expose to the elements. This box can also be made of a rigid plastic. In addition, the design and the capacity of the multiple purposes box can varied according to particular user's needs as well as the roof or tarpaulin's measures. For instance, the multiple purposes box can be designed not taking into account the shape, as long as the frontal angles of the vehicle's windshield are respected, in order to keep the aerodynamic line and to offer less air or wind resistance.

Multiple purposes box includes a couple of handles 43 in the frontal part to be pushed or to be pulled, meaning inserting and extracting the box of the holding rack. Preferably, the handlers 43 are constituted by halves so the handlers are in the base of the box 45 and in the cover 46, which when the multiple purposes box is closed, they are supplementary with each other to constitute the handlers 43. These handlers 43 includes holes in both sides for padlocks from preventing the box of being open. In addition, the multiple purposes box has a couple of clasps to prevent the box to open when the vehicle is moving.

The connecting member 42 is a component of the multiple purposes box 40 which is found in the inferior section of the base of the box 45, which will be inserted sliding between the rails 22 in the holding rack 10 of the current invention. The connecting member 24 consists of a varied number of sliding elements 47, which slide firmly within the space of the rails or lanes 22 to get and lock the multiple purposes box 40 in the holding rack 10. The sliding elements 47 are placed in parallel divided by the wide part of the multiple purposes box 40.

The settings that can adopt the sliding elements 47, as well as the number of them, depend on the number and shape of the transverse elements 20 of the superior member 12 of the holding rack 10.

Even when certain embodiment has been described and illustrated, there are many possible modifications that has to be highlighted. Therefore, the current invention should not be considered as limited, except from the previous techniques demands and from the attached claims desires.

1. A holding rack to be used in the vehicles roof, hood or curved, semi-flat or flat tarpaulin is distinguished because it includes:
an inferior member placed adjacently to the roof or tarpaulin or flat surface of the vehicle, being such inferior member fixed directly and removable to such flat vehicle's surface, where the inferior member allows to install/remove easily form the holding rack;
a middle member placed adjacently to an linked to the inferior member of the holding rack. This inferior member constitutes the base structure where the superior member and the inferior member are going to be attached to fix the holding rack setting;
and a superior member places adjacently and combined to the middle member, where the superior member includes a variety of transverse elements place, fixed and locked to the middle member, which sets, along with the middle member of the holding rack different spaces to be used as rails to allow the insertion and locking of the multiple purposes box.

2. The holding rack to be used in a hood or roof or curved, semi-flat and flat tarpaulin of any vehicle, according to claim 1, distinguished because the middle member includes a couple of longitudinal elements set in parallel and divided, where these longitudinal elements has flat inferior and superior surfaces to get the superior and inferior members attached.

3. The holding rack to be used in a hood or roof or curved, semi-flat and flat tarpaulin of any vehicle, according to claim 2, distinguished because the longitudinal elements of the middle member are identical and already have a selected square, rectangular parallelepiped and similar shape.

4. The holding rack to be used in a hood or roof or curved, semi-flat and flat tarpaulin of any vehicle, according to claim 1, distinguished because the superior member includes different transverse elements placed and locked on the longitudinal elements of the middle member, where these transverse elements are placed perpendicularly to the longitudinal elements of the middle member and are divided with equal distances in parallel.

5. The holding rack to be used in a hood or roof or curved, semi-flat and flat tarpaulin of any vehicle, according to claim 4, also distinguished because this holding rack includes a superior member set up by three transverse elements, two of them are placed near the ends of the longitudinal elements of the middle element, and the third transverse element is placed at the middle between the ends of those longitudinal elements.

6. The holding rack to be used in a hood or roof or curved, semi-flat and flat tarpaulin of any vehicle, according to claims 1 and 4, also distinguished because the transverse elements of the superior member can be shown in different transversal ways such as triangle, (kite tail type), square, rectangle round, star-shape (from 2 to 6 points), in any supplementary shape that can be easily adapted to the inferior section of the multiple purposes box.

7. The holding rack to be used in a hood or roof or curved, semi-flat and flat tarpaulin of any vehicle, according to claims 1 and 4, also distinguished because the superior and middle members can be manufactured in any rigid material, are preferably made of plastic due to the flexibility, lightness and resistance to the environment.

8. The holding rack to be used in a hood or roof or curved, semi-flat and flat tarpaulin of any vehicle, according to claim 1, also distinguished because the inferior member includes at least two pairs of holding members to lock and keep the holding rack to the vehicle's roof, each of one the holding member pairs can be found in the inferior surface on each end of the longitudinal elements of the middle member.

9. The holding rack to be used in a hood or roof or curved, semi-flat and flat tarpaulin of any vehicle, according to claim 1, also distinguished because the inferior member includes at least a pair of holding members that can be within the material of the longitudinal members of the middle member.

10. The holding rack to be used in a hood or roof or curved, semi-flat and flat tarpaulin of any vehicle, according to claims 8 and 9, also distinguished because the holding members can be selected from any kind of holding members which allow an easy install/remove mechanism to the holding rack like a suction pad, where the suctions pads include a activating mechanism of a movable lever, when activated it causes vacuum and the suction pads stick to the vehicle's roof, hood, tarpaulin or curved, flat or semi-flat surface.

11. The holding rack to be used in a hood or roof or curved, semi-flat and flat tarpaulin of any vehicle, according to claim 2, also distinguished because the middle member has a groove on each ends of the longitudinal in order to activate the movable lever of the holding member, each groove or gap are diagonally set as to allow the activation of the vacuum levers to the holding members and to install easily the holding rack.

12. The holding rack to be used in a hood or roof or curved, semi-flat and flat tarpaulin of any vehicle, according to claim 1, also distinguished because the holding rack includes a tie member and a locking frontal member, being each one placed in the sides of the holding rack and goes longitudinally in parallel to the longitudinal middle member, being such tie element and frontal locking member from preventing the multiple purposes box, once is on the rails 22, slide out and to lock it into position respectively,

13. Multiple purposes box to be used in a holding rack, the box includes a main body that is constituted by a base and a cover in which length and width measures of the base and cover and supplementary between them to limit an internal space to be used for luggage, the multiple purpose is distinguished because it includes a connecting member that is found in the inferior area of the base of the box, which will be inserted by sliding the rails of the holding rack, where the connecting member includes a varied number of sliding elements which move within the rails in the holding rack and to lock the multiple purposes box to the holding rack.

14. The multiple purposes box to be used in a holding rack according to claim 13, distinguished because the sliding elements are placed separated in parallel in the wide area of the multiple purposes box; this box includes in the frontal view a pair of handlers to push or pull the box of that is in the holding rack, those handlers are constituted by supplementary halves which are part from the base and the cover, when the multiple purposes box is closed the halves complement one another to constitute the handler and they also have grooves to be used by padlocks from preventing the box of being open.

15. The multiple purposes box to be used in a holding rack according to claim 13, also distinguished by the settings that sliding elements can take, as well as their number, it will depend on the size and number or transverse elements of the superior member 12 of the holding rack.
